(19) United States
(12) Patent Application Publication
(10) Pub. No.: US 2017/0352066 A1
(43) Pub. Date: Dec. 7, 2017

(54) METHOD AND SYSTEM OF CHARITY-BASED E-COMMERCE FOR GOODS AND SERVICES

(71) Applicants: Phanni K Viswanadham, Cupertino, CA (US); Sundari Konakalla, cupertino, CA (US); Bhavya R. Panuganti, San Jose, CA (US)

(72) Inventors: Phanni K Viswanadham, Cupertino, CA (US); Sundari Konakalla, cupertino, CA (US); Bhavya R. Panuganti, San Jose, CA (US)

(21) Appl. No.: 15/591,424

(22) Filed: May 10, 2017

Related U.S. Application Data
(60) Provisional application No. 62/344,401, filed on Jun. 2, 2016.

(51) Int. Cl. G06Q 30/02; G06Q 20/20

(52) U.S. Cl. CPC G06Q 30/0279; G06Q 20/204

(57) ABSTRACT

In one aspect, a computerized method for charity-based e-commerce for goods and services including the step of receiving a posting for a commercial transaction on an e-commerce website specifying the proceeds from that offer benefit a charity organization registered on the e-commerce to benefit from such offers. The computerized method includes the step of enabling a set of users to browse a set of postings comprising one or more specific charities of their interest. The computerized method includes the step of receiving a selection of a charity from the user. The computerized method includes the step of facilitating the commercial transaction on the e-commerce website. The computerized method includes the step of transferring the profits from the commercial transaction to the selected charity. The commercial transaction includes one or more commercial goods. The commercial transaction includes one or more commercial services. The commercial transaction includes one or more event tickets. The commercial transaction includes one or more commercial coupons (e.g. third-party merchant promotions, etc.).

### CROSS-REFERENCE TO RELATED APPLICATIONS

This application claims priority to U.S. Provisional Application No. 62/344,401, titled and METHOD AND SYSTEM OF CHARITY-BASED E-COMMERCE FOR GOODS AND SERVICES filed on 2 Jun. 2016. This provisional application is incorporated by reference in its entirety.

### BACKGROUND

### 1. Field

This application relates computerized services and more specifically to a system, article of manufacture and method for automatic charity-based e-commerce for goods and services.

### 2. Related Art

Inventors have been volunteering for and involved in non-profit organizations for several years. They realized that funding and fundraising for non-profits is an arduous process with lot of uncertainty. Inventors realized that membership of and the community that served by non-profits should be able to directly and indirectly fund these organization by tapping into a share of their economic activity. An online e-commerce market place leveraging latest Internet and cloud computing technologies will be able to effectively tap in to this economic activity in a very scalable and cost effective manner to provide continuous funding and financial support to both non-profits and for profit enterprises. Also, such a market place will help these enterprises to run their outreach activities such as membership drive, volunteering activities and commercial services. The online e-commerce market place will prove to be a very viable business.

### BRIEF SUMMARY OF THE INVENTION

In one aspect, a computerized method for charity-based e-commerce for goods and services including the step of receiving a posting for a commercial transaction on an e-commerce website specifying the proceeds from that offer benefit a charity organization registered on the e-commerce to benefit from such offers. The computerized method includes the step of enabling a set of users to browse a set of postings comprising one or more specific charities of their interest. The computerized method includes the step of receiving a selection of a charity from the user. The computerized method includes the step of facilitating the commercial transaction on the e-commerce website. The computerized method includes the step of transferring the profits from the commercial transaction to the selected charity. The commercial transaction includes one or more commercial goods. The commercial transaction includes one or more commercial services. The commercial transaction includes one or more event tickets. The commercial transaction includes one or more commercial coupons (e.g. third-party merchant promotions, etc.).

### BRIEF DESCRIPTION OF THE DRAWINGS

FIG. 1 illustrates an example system of a charity-based e-commerce entity, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example charity-based e-commerce process according to some embodiments.

FIG. 5 illustrates an example process for organizing volunteers and volunteering services for charities, according to some embodiments.

FIG. 6 illustrates another example process for managing the awarding of deed points to a user, according to some embodiments.

The Figures described above are a representative set, and are not an exhaustive with respect to embodying the invention.

### DESCRIPTION

Disclosed are a system, method, and article of manufacture for method and system of charity-based e-commerce for goods, services, volunteering and/or fundraising/events. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Application programming interface (API) can specify how software components of various systems interact with each other.

Charitable organization can be a type of non-profit organization (NPO). It can center on philanthropic goals as well as social well-being (e.g. charitable, educational, religious, or other activities serving the public interest or common good).

Cloud computing can involve deploying groups of remote servers and/or software networks that allow centralized data storage and online access to computer services or resources. These groups of remote serves and/or software networks can be a collection of remote computing services.

E-commerce can include the trading or facilitation of trading in products or services using computer networks, such as the Internet.

E-commerce payment system facilitates the acceptance of electronic payment for online transactions.

Location-based service (LBS) can be a mobile-device feature utilizing location information, such as a global positioning service (GPS), etc.

### Exemplary Methods and Systems

Various example processes and/or systems for a charity-based e-commerce entity that provides consumer-to-consumer and/or business-to-consumer sales and/or services via the Internet. The charity-based e-commerce entity can enable users to offer various goods and/or services for sale on one or more web sites and/or organize volunteering activities, conduct fundraising events. The charity-based e-commerce entity can enable other users to purchase said goods and/or services on the one or more web sites. The charity-based e-commerce entity can enable a posting user to specify one or more charitable organizations (e.g. religious entities, non-profit entities, humanitarian entities, animal welfare entities, non-profit medical service providers, etc.) to receive any and/or all profits from the sale of the goods and/or services. The charity-based e-commerce entity can receive a specified percentage of the sale value as well. In some embodiments, selling users can be specified a plurality of charitable organizations to receive a pro-rated portion of the sale of the goods and/or services.

A good can include an item offered for sale (e.g. furniture, cars, bicycles, appliances, electronic goods, foods, toys, sporting equipment, medical supplies, etc.). A service can include a professional service, repair service, medical service, educational/tutoring/coaching service, entertainment, etc. These listed goods and/or services and/or organize volunteering activities, conduct fundraising events are provided by way of example and not of limitation.

In some examples, the charity-based e-commerce entity can aggregate various other e-commerce entity websites/services into a seamless single e-commerce website. For example, a church can offer a set of goods for sale for charitable purposes. A medical charity can operate another e-commerce website for charitable purposes. A school can also operate yet another e-commerce website for charitable purposes. A high-school sports team can operate still yet another e-commerce website for charitable purposes. The charity-based e-commerce entity can aggregate the content of all these charitable-oriented e-commerce websites into a single charity-oriented website. The continuity of the various assigned benefactors of the individual charitable e-commerce website can be maintained during the aggregation process. In this way, the potential user-base of the various individual charity-based e-commerce entities can be expanded by sharing their user-bases across a single aggregated the charity-based e-commerce entity.

Accordingly, a charity organization can register with the charity-based e-commerce entity. The charity-based e-commerce entity can provide a dashboard for an administrator of a charity organization to upload information, available charities to benefit form sales, a list of users that can list goods and/or services on behalf of the charitable organization, etc. It is noted that charity-based e-commerce entity can save sales-donations for various users that utilize it to sell goods and/or services for charity organizations. Records of these sales-donations can be sent to the respective user and/or user's accountant in an electronic format (e.g. for tax records, etc.).

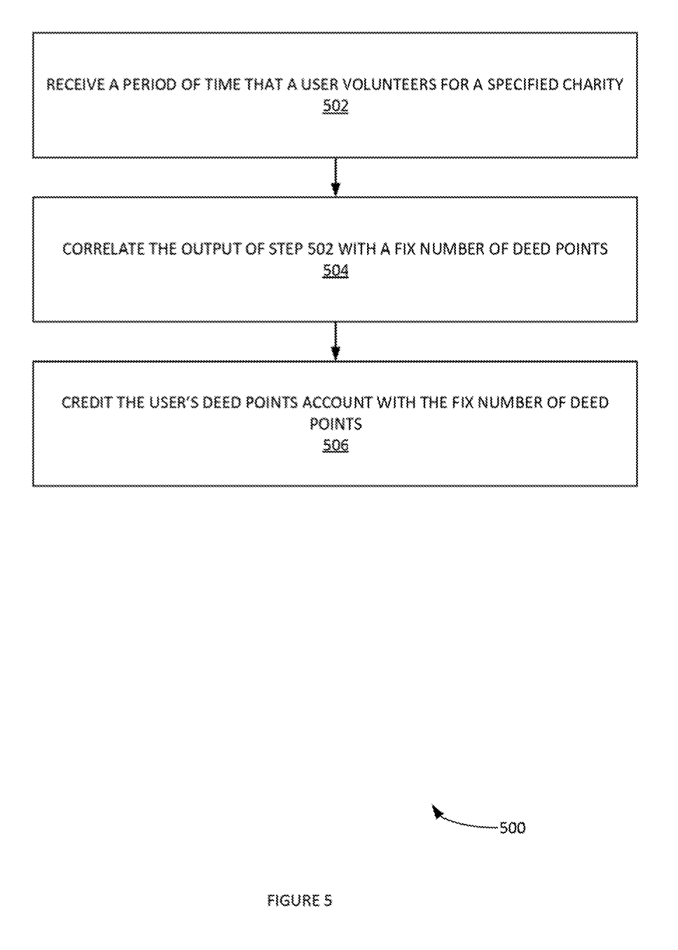

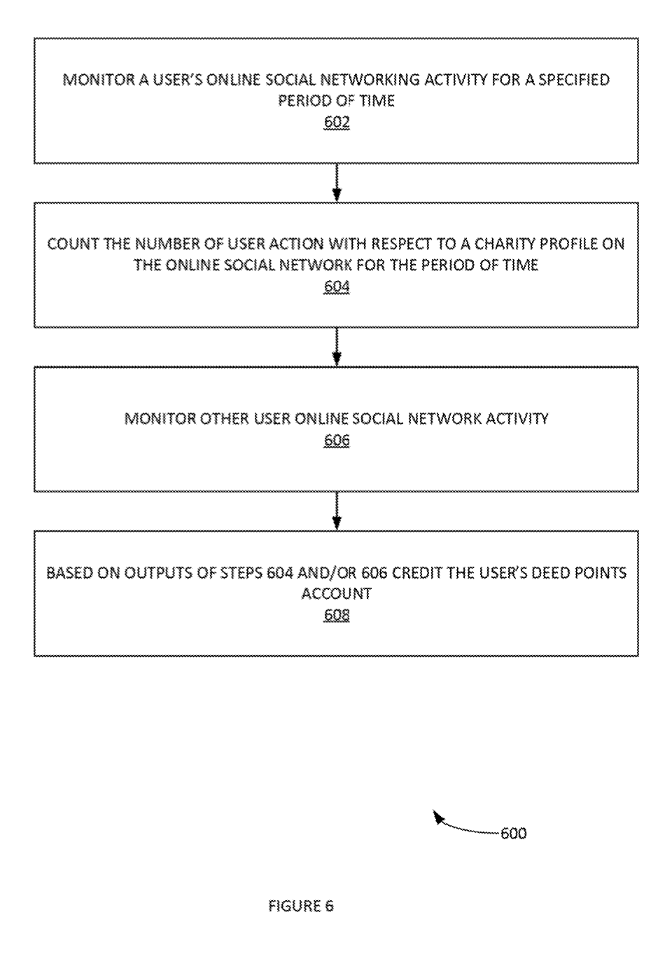

By selling and/or buying goods and/or services via the charity-based e-commerce entity, users can accumulate deed points. A deep point can be a metric that signifies a user's cumulative charitable contributions and/or other behaviors. For example, a user can accumulate a deed point for every dollar that is donated to charity on behalf of the user's sales on the charity-based e-commerce entity. In another example, a user can accumulate half a deed point for every dollar spent on the charity-based e-commerce entity. These examples are provided by way of illustration and not limitation. In other example embodiments, other schemes of awarding deed points can be implemented. A user's deed points can be used for various ‘big data’ and/or social networking analytics. Additionally, corporations can utilize a charity-based e-commerce entity to implement charitable campaigns. Employee deed points can be calculated for rewards with in the corporation. Educational institutions can utilize a charity-based e-commerce entity to implement charitable campaigns. Students' and/or teachers' deed points can be calculated for rewards with in the corporation. For example, a set of fraternities can utilize the charity-based e-commerce entity to hold a contest to determine which fraternity can accumulate the most deed points within a specified period of time. Example deed point acquisition processes are discussed infra with respect to FIGS. 5 and 6.

The charity-based e-commerce entity can rate charity organizations using various methodologies. These can include third-party ratings, user-feedback ratings, etc.

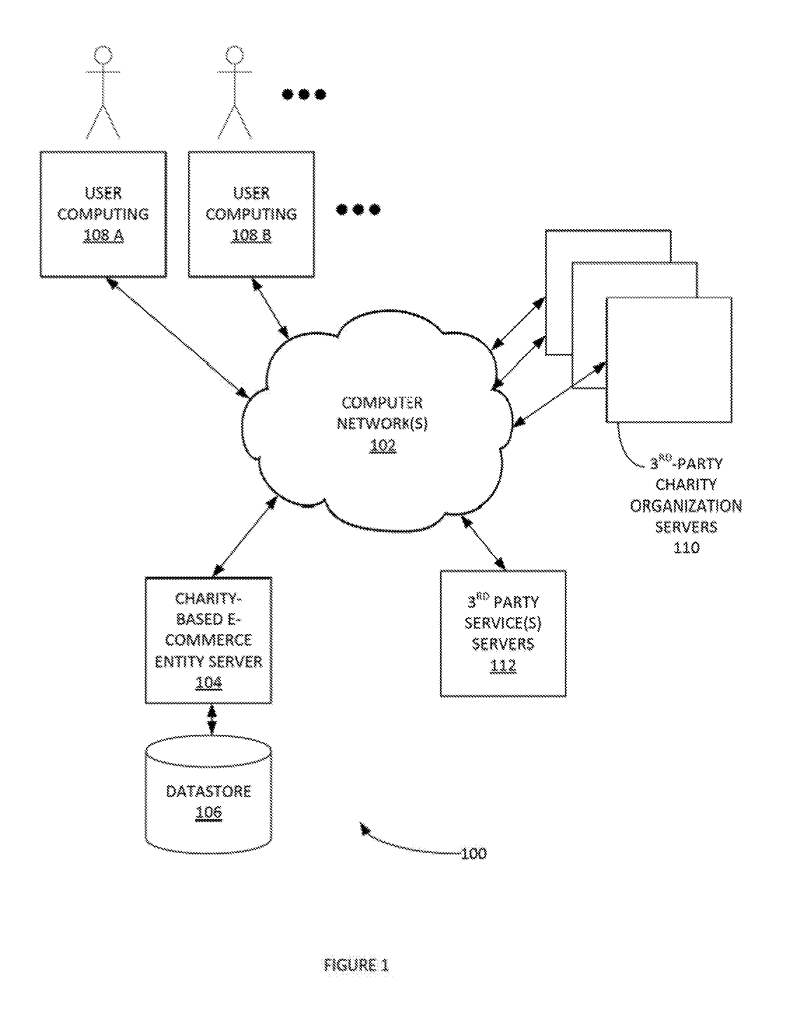

FIG. 1 illustrates an example system 100 of a charity-based e-commerce entity, according to some embodiments. The various entities of system 100 can electronically communicate via computer network(s) 102. Computer network(s) 102 can include, inter alia: the Internet, cellular data networks, enterprise data networks, etc. System 100 can include a charity-based e-commerce entity server 104. Charity-based e-commerce entity server 104 can implement the various charity-based e-commerce entity functionalities provided supra. Charity-based e-commerce entity server 104 can implement an e-commerce website wherein users 108 A-B can sell goods and/or services with the proceeds of said sales donating to a specified charity. Charity-based e-commerce entity server 104 can include one or more webservers, data security systems, search engines, statistical and/or machine learning systems, etc. Charity-based e-commerce entity server 104 can include an e-commerce payment system for online money transfers serve as well as ‘traditional’ paper methods like checks, wire transfers and/or money orders. Charity-based e-commerce entity server 104 can also include systems for supporting payments/donations using digital assets and payment systems (e.g. bitcoin®, etc.). Charity-based e-commerce entity server 104 can provide an API for third-party charity organization(s) 110 to upload their respective charity-based e-commerce systems to a unified e-commerce website managed by charity-based e-commerce entity server 104. For example, a Hindu temple charity organization can utilize the API provided by Charity-based e-commerce entity server 104 to create its own charity-based e-commerce entity platform and integrate said platform into the overall website of charity-based e-commerce entity server 104 that includes other charity organizations. It is noted that individual charitable organizations can be provided the option of screen out offerings by other charitable organizations. In this way, charitable organizations can opt not to support/integrate with other charities with differing/contradictory ideological, religious and/or political viewpoints. It is noted that various entities of system 100 can be implemented in cloud-computing platforms according to various embodiments.

Charity-based e-commerce entity server 104 can use automatic charity donation tracking to calculate various tax deductions for both state and/or federal governments. Reports can be automatically generated for business purposes that can then be used to report for reimbursement and potentially a tax deduction with the IRS. Reports can be automatically formatted in an electronic format that can be made accessible to various tax preparation software package. An API can be generated for tax preparation servers can access relevant charitable donation information from charity-based e-commerce entity server 104. Charity-based e-commerce entity server 104 can also track a user's and/or institution's (e.g. a corporation, a religious organization, a fraternal organization, etc.) deed points (see supra). Charity-based e-commerce entity server 104 can include an API that enables deed points of users and/or institutions. In some embodiments, social networks (e.g. Facebook®, LinkedIn®, etc.) can automatically display deed points of their respective members. Deed points can be utilized for various statistical, demographic, sociological and/or business analytics.

It is noted that the storage systems, computing systems, and/or network systems that constitute the infrastructure for the e-commerce platform can be implemented in a cloud-computing platform utilizing virtualization, geographic redundancy and/or scaling principles for resources, capacity, fault tolerance and/or ease of administration. Users (e.g. buyers, sellers, etc.), charity organizations, third-party promoters can access the cloud-hosted e-commerce system (e.g. a Top Deeds market place, etc.) through any web service and/or client application on any Internet connected device (e.g. computers, smart phones or other appliances).

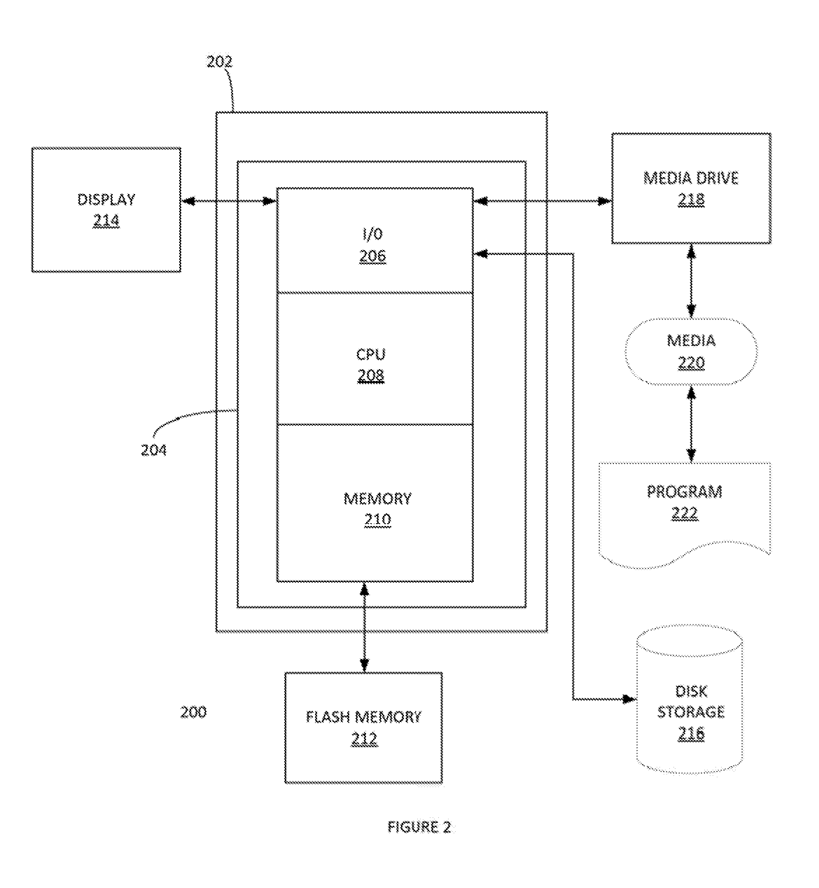

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication, protocols such a Wi-Fi, Bluetooth® (and/or other standards for exchanging data over short distances includes those using short-wavelength radio transmissions), USB, Ethernet, cellular, an ultrasonic local area communication protocol, etc.

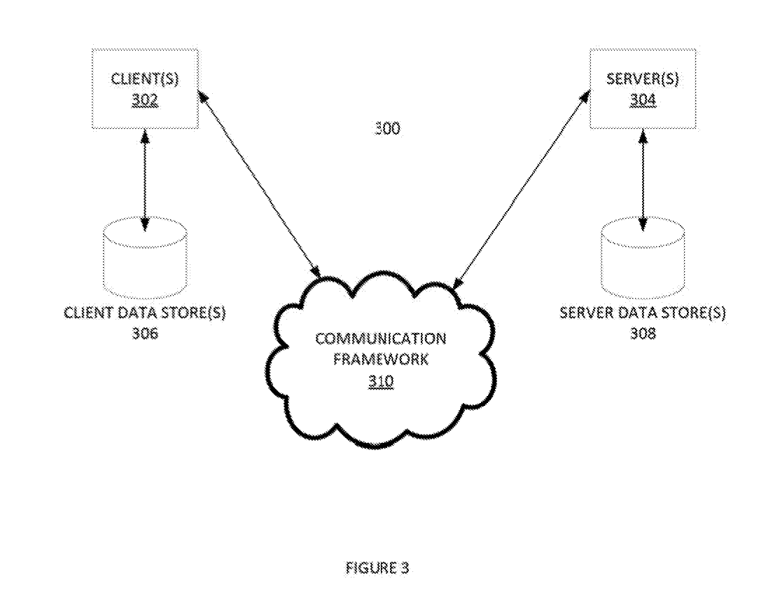

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### Example Methods

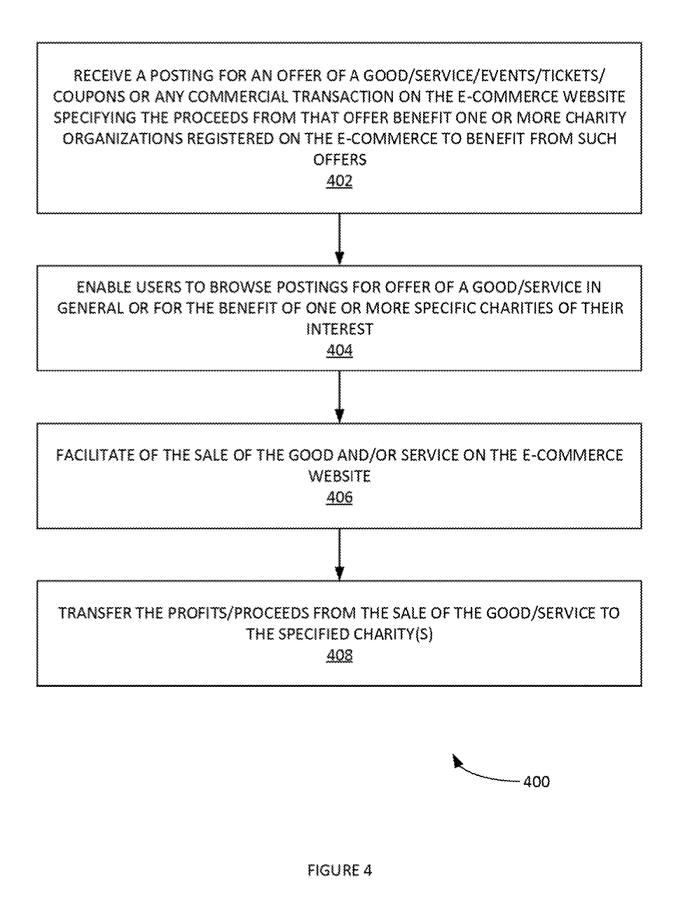

FIG. 4 illustrates an example charity-based e-commerce process 400, according to some embodiments. In step 402, process 400 receives a user posting for a good and/or service on an e-commerce website. For example, process 400 can receive a posting for an offer of a good/service/events/tickets/coupons/volunteer opportunity or any commercial transaction on the E-Commerce website specifying the proceeds from that offer benefit one or more charity organizations registered on the e-commerce to benefit from such offers.

In step 404, process 400 receives a notification from user of a charity organization to donate the profit from the sale good and/or service on the e-commerce website. For example, users browse postings for offer of a good/service in general or for the benefit of one or more specific charities of their interest. It is further noted that postings may be used to mobilize, manage invitations and track the volunteering and fund raising activity.

In step 406, process 400 facilitates of the sale of the good and/or service on the e-commerce website. In step 408, process 400 transfers the profits from the sale of the good and/or service to the charity organization selected by the user. Process 400 can transfer the profits/proceeds from the sale of the good/service to the specified charity(ies). Additionally, it is noted that location based services (LBS) can be utilized by process 400. Process 400 can provide a dashboard that enables users to browse for listings or organizations based on their current location and/or a location of their choice.

FIG. 5 illustrates an example process 500 for organizing volunteers and volunteering services for charities, according to some embodiments. In step 502, process 500 can receive a period of time that a user volunteers for a specified charity. For example, the user can volunteer at a charity. The user can input his/her volunteer time into a mobile application. The mobile application can send the volunteer time to a server implementing process 500. In step 504, process 500 can correlate the output of step 502 with a fix number of deed points. For example, each hour of volunteering at a specified charity can be set to a fixed number of deed points. In step 506, process 500 can credit the user's deed points account with the fix number of deed points.

FIG. 6 illustrates another example process 600 for managing the awarding of deed points to a user, according to some embodiments. Using process 600, users can convert various online social network activity (e.g. likes, re-tweets, shares of any approved material, etc.) to deed points. Process 600 can be used to recognize and value the content that benefits the social causes. For example, a charity organization or a cause can be shared on the online social network. The use can then like, share and/or forward this information on his/her online social network. Process 600 can obtain this information from an API of the online social network. In one example, every ten (10) of those likes or shares can be used by process 600 to award the user one (1) deed point to their account. In another example, various socially beneficial content shared on social networks can also garner deed points for the user.

More specifically, in step 602, process 600 can monitor a user's online social networking activity for a specified period of time. In step 604, process 600 can count the number of user action with respect to a charity profile on the online social network for the period of time. In step 606, process 600 can monitor other user online social network activity. In step 608, based on outputs of steps 604 and/or 606, process 600 can credit the user's deed points account.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for charity-based e-commerce for goods and service comprising:
receiving a posting for a commercial transaction on an e-commerce website specifying the proceeds from that offer benefit a charity organization registered on the e-commerce to benefit from such offers;
enabling a set of users to browse a set of postings comprising one or more specific charities of their interest;
receiving a selection of a charity from the user;
facilitating the commercial transaction on the e-commerce website; and
transferring the profits from the commercial transaction to the selected charity.

2. The computerized method of claim 1, wherein the commercial transaction comprises one or more commercial goods.

3. The computerized method of claim 2, wherein a user's computing device accesses a web site managed by the e-commerce platform, and herein the user browses a set of postings for offers of a good in general.

4. The computerized method of claim 2, wherein the user's computing device accesses a web site managed by the e-commerce platform, and wherein the user browses another set of postings for offers of one or more specific charities of interest to the user.

5. The computerized method of claim 1, wherein the commercial transaction comprises one or more commercial devices.

6. The computerized method of claim 1, wherein the commercial transaction comprises one or more event tickets.

7. The computerized method of claim 1, wherein the commercial transaction comprises one or more commercial coupons.

8. The computerized method of claim 7, wherein the commercial coupons are provided by a third-party merchant promotion.

9. A server system for managing an online charity-based e-commerce platform comprising:
a processor;
a memory containing instructions when executed on the processor, causes the processor to perform operations that:
receiving a posting for a commercial transaction on an e-commerce website specifying the proceeds from that offer benefit a charity organization registered on the e-commerce to benefit from such offers;
enable a set of users browse a set of postings comprising one or more specific charities of their interest;
receive a selection of a charity from the user;
facilitate the commercial transaction on the e-commerce website; and
transfer the profits from the commercial transaction to the selected charity.

10. The server system of claim 9, wherein the commercial transaction comprises one or more commercial goods.

11. The server of claim 10, wherein a user's computing device accesses a web site managed by the e-commerce platform, and wherein the user browses a set of postings for offers of a good in general.

12. Thee server system of claim 10, wherein the user's computing device accesses a web site managed by the e-commerce platform, and wherein the user browses another set of postings for offers of one or more specific charities of interest to the user.

13. The server system of claim 9, wherein the commercial transaction comprises one or more commercial services.

14. The server system of claim 9, wherein the commercial transaction comprises one or more event tickets.

15. The server system of claim 9, wherein the commercial transaction comprises one or more commercial coupons.

16. The server system of claim 9, wherein the server system is implanted in a cloud-computing platform.

17. The server system of claim 16, wherein the commercial coupons are provided by a third-party merchant promotion.

18. The server system of claim 9, wherein the commercial transaction comprises a volunteering event and wherein a time spent volunteering is used as a proxy for the profits from the commercial transaction.

19. The server system of claim 9, wherein a credit for the commercial transaction comprises a deed point.
